(19) United States
(12) Patent Application Publication
(10) Pub. No.: US 2025/0276883 A1
(43) Pub. Date: Sep. 4, 2025

(54) INDUSTRIAL VEHICLE

(71) Applicant: KABUSHIKI KAISHA TOYOTA JIDOSHOKKI, Kariya-shi (JP)

(72) Inventor: Hirokazu KISHIDA, Kariya-shi (JP)

(73) Assignee: KABUSHIKI KAISHA TOYOTA JIDOSHOKKI, Kariya-shi (JP)

(21) Appl. No.: 19/062,330

(22) Filed: Feb. 25, 2025

(30) Foreign Application Priority Data
Mar. 1, 2024 (JP) 2024-031490

(51) Int. Cl. B66F 9/06; B66F 9/075

(52) U.S. Cl. CPC B66F 9/063; B66F 9/07509; B66F 9/0755; B66F 9/07554

(57) ABSTRACT

An industrial vehicle capable of manned travel and unmanned travel by the automated operation includes a vehicle body; and an automated operation unit that is mounted on the vehicle body and in which a plurality of devices for automated operation is integrated. The plurality of devices includes: an automated operation controller controlling the automated operation; a display device on which information related to the automated operation is displayed; an input device on which data related to the automated operation is input; and an emergency stop device causing an emergency stop of the automated operation. The automated operation unit includes an accommodation case accommodating the automated operation controller, the display device, the input device, and the emergency stop device. The accommodation case is positioned in the vehicle body at a height equal to or lower than a height that does not obstruct an operator's view during the manned travel.

### CROSS-REFERENCE TO RELATED APPLICATION

This application claims priority to Japanese Patent Application No. 2024-031490 filed on Mar. 1, 2024, the entire disclosure of which is incorporated herein by reference.

The present disclosure relates to an industrial vehicle, and more particularly to an industrial vehicle capable of unmanned and manned travel.

### BACKGROUND ART

In recent years, unmanned travel by automated operation of an industrial vehicle such as a forklift truck has been realized, and Japanese Patent Publication No. 5856362 discloses a forklift truck for manned and unmanned operation. For this type of the forklift truck, an existing man-operated forklift truck is modified to achieve the automated operation. Therefore, devices necessary for the automated operation are additionally mounted on the existing man-operated forklift truck.

However, since there is not enough space in a vehicle body of the man-operated forklift truck, it is not possible to accommodate all devices (except for sensors) necessary for automated operation inside the forklift truck for the manned and unmanned operation. For this reason, it is necessary to consider where and how to install the devices necessary for the automated operation. For example, in a case of a forklift truck, it is possible to install the equipment necessary for the automated operation in a head guard that protects the driver's seat, but there is a risk that the devices necessary for the automated operation may obstruct the operator's view when the vehicle is being operated by an operator. In addition, since the devices are installed at high positions, it is difficult to perform maintenance work on the devices. Although it is possible to provide the devices necessary for the automated operation inside the counterweight, it requires a dedicated counterweight, which increases manufacturing costs.

The present disclosure has been made in view of the above problems, and is directed to providing an industrial vehicle that secures an operator's view during manned operation and has excellent workability on an automated operation unit.

### SUMMARY

In accordance with an aspect of the present disclosure, there is provided an industrial vehicle capable of manned travel and unmanned travel by the automated operation. The industrial vehicle includes a vehicle body; and an automated operation unit that is mounted on the vehicle body and in which a plurality of devices for automated operation is integrated. The plurality of devices includes an automated operation controller that controls the automated operation, a display device on which information related to the automated operation is displayed, an input device on which data related to the automated operation is input, and an emergency stop device that causes an emergency stop of the automated operation. The automated operation unit includes an accommodation case that accommodates the automated operation controller, the display device, the input device, and the emergency stop device. The accommodation case is positioned in the vehicle body at a height equal to or lower than a height that does not obstruct an operator's view during the manned travel.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a side view of a forklift truck according to a first embodiment;

FIG. 2 is a perspective view of the forklift truck according to the first embodiment;

FIG. 3 is a perspective view of a main part of the forklift truck according to the first embodiment, as viewed from the rear left;

FIG. 4 is a perspective view of the main part of the forklift truck according to the first embodiment, as viewed from the rear right;

FIG. 5 is a perspective view illustrating devices accommodated in an automated operation unit;

FIG. 6 is a perspective view illustrating a state in which the automated operation unit is displaced rearward relative to a right pillar; and

FIG. 7 is a side view of a forklift truck according to a second embodiment.

### DETAILED DESCRIPTION OF THE EMBODIMENTS

### First Embodiment

Hereinafter, an industrial vehicle according to a first embodiment will be described with reference to the accompanying drawings. The industrial vehicle of the present embodiment is a battery-powered forklift truck that is capable of unmanned travel by an automated operation, and manned travel driven by an operator. In the following description, “front-rear”, “left-right”, and “up-down” directions are defined with respect to an operator sitting in a driver's seat of the forklift truck and facing the forward direction of the forklift truck. Firstly, the forklift truck will be described.

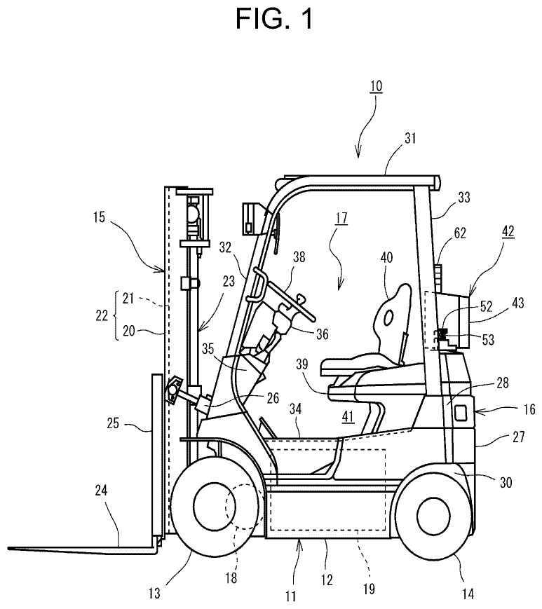

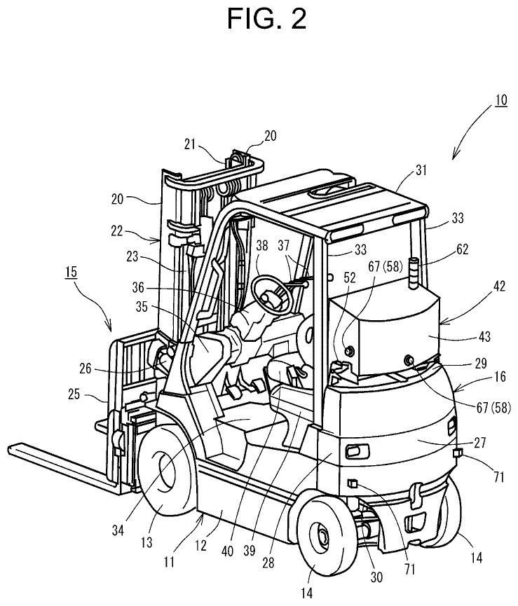

As illustrated in FIGS. 1 and 2, a vehicle body 11 of a forklift truck 10 includes a main body 12. The forklift truck 10 includes front wheels 13 provided in a front of the main body 12, and rear wheels 14 provided in a rear of the main body 12. The front wheels 13 are driving wheels and the rear wheels 14 are steered wheels. A cargo handling device 15 is disposed in the front of the main body 12, and a counterweight 16 is disposed in the rear of the main body 12. A driver's seat 17 is provided near the center of the main body 12. The main body 12 is equipped with a travel motor 18 as a driving power source for traveling, and also a battery 19 for storing electric power for driving the travel motor 18.

The cargo handling device 15 includes a mast 22 having outer masts 20 and inner masts 21. A pair of left and right outer masts 20 is provided with the inner masts 21 which are slidable inside the outer masts 20. The mast 22 includes a lift cylinder 23 of a single-action type that is operated by hydraulic oil. With the operation of the lift cylinder 23, the inner masts 21 slide to move up and down within the outer masts 20.

A pair of left and right forks 24 for supporting a cargo W is attached to the mast 22 via a lift bracket 25. The lift bracket 25 is configured to move up and down relative to the inner mast 21. A tilt cylinder 26 of a reciprocating type that is operated by hydraulic oil is provided between the main body 12 and the outer masts 20. The mast 22 tilts forward and backward with the lower end of the mast 22 as a fulcrum with an operation of the tilt cylinder 26. The tilt cylinder 26 is operated by supplying and discharging hydraulic oil.

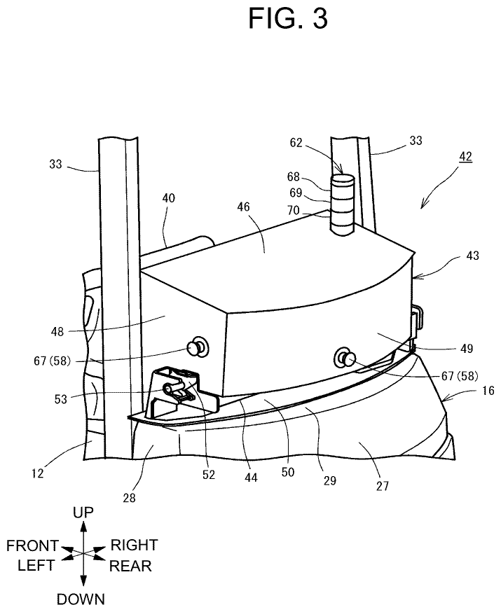

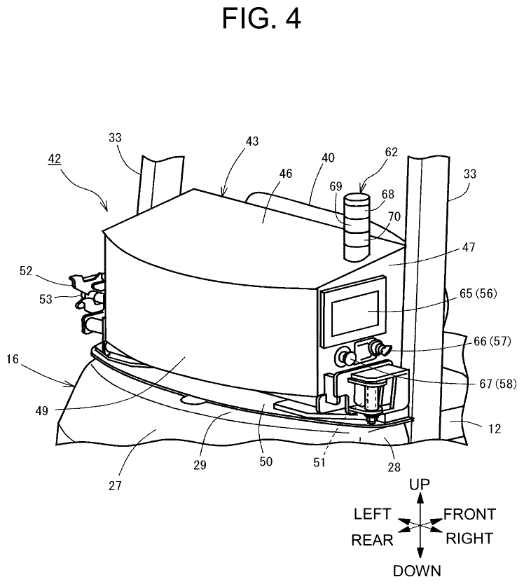

The counterweight 16 is disposed in the rear of the main body 12. The counterweight 16 is used for adjustment of the weight of the forklift truck 10 and weight balance of the vehicle body 11. As illustrated in FIGS. 3 and 4, the counterweight 16 has a rear surface 27 that is curved in an arc shape so as to protrude rearward in a plan view, a pair of left and right side surfaces 28, and a flat top surface 29. As illustrated in FIGS. 1 and 2, a wheel house 30 for the rear wheels 14 is disposed across the main body 12 and the counterweight 16.

As illustrated in FIGS. 1 and 2, a head guard 31 is disposed above the driver's seat 17. The head guard 31 is supported by a pair of left and right front pillars 32 disposed in the front of the main body 12 and a pair of left and right rear pillars 33 provided in the rear of the main body 12. The main body 12 has a toe board 34 that forms the floor surface of the driver's seat 17. The battery 19 is disposed below the toe board 34. As illustrated in FIG. 2, an instrument panel 35 is provided in front of the toe board 34. The instrument panel 35 has a steering column 36 and a plurality of cargo handling levers 37. The steering column 36 supports a steering wheel 38.

A seat stand 39 is disposed behind the toe board 34 on the main body 12. The seat stand 39 is openable and closable. A driver's seat 40 is mounted on the seat stand 39. The seat stand 39 has a recess 41 that is recessed rearward (see FIG. 1) in the front portion of the seat stand 39. When the battery 19 is to be replaced, the toe board 34 is removed and the seat stand 39 is rotated toward the counterweight 16, which allows the battery 19 to be removed from the main body 12. The vehicle body 11 of the present embodiment includes at least the counterweight 16, the head guard 31, the front pillars 32, the rear pillars 33, the toe board 34, the instrument panel 35, and the seat stand 39, in addition to the main body 12.

The forklift truck 10 of the present embodiment includes an automated operation unit 42 mounted on the counterweight 16, which is a part of the vehicle body 11, and behind the driver's seat 40. In the present embodiment, the automated operation unit 42 is added to a forklift truck of an existing design that can be driven by an operator to realize the forklift truck 10 capable of manned and unmanned operation. In order to achieve the automated operation of the forklift truck 10, a plurality of devices for automated operation that enables unmanned travel (hereinafter referred to as a device group for automated operation) is required. Most of the device group for the automated operation is integrated in the automated operation unit 42.

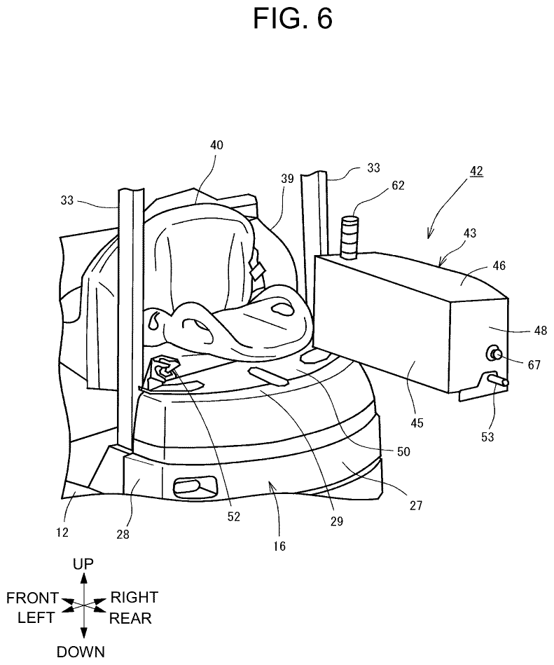

As illustrated in FIGS. 3, 4, and 5, the automated operation unit 42 includes an accommodation case 43 that accommodates the device group for the automated operation. The accommodation case 43 has a bottom 44, a front plate 45, an upper plate 46, a right plate 47, a left plate 48, and a rear plate 49. The bottom 44 is the bottom of the accommodation case 43 and is formed by a frame. As illustrated in FIG. 6, the front plate 45 is formed of a plate member extending vertically from a front portion of the bottom 44. The upper plate 46 is formed of a plate member that is connected to an upper portion of the front plate 45, and forms an upper surface of the accommodation case 43. The upper plate 46 is inclined downward from the front to the rear. Specifically, the upper plate 46 is inclined so that the automated operation unit 42 is positioned at a height equal to or lower than a predetermined height, and equal to or lower than a height of the driver's seat 40. The height and the inclination of the upper plate 46 are set so that the automated operation unit 42 does not obstruct a rear view of the operator during the manned operation. Thus, the accommodation case is positioned in the vehicle body at a height equal to or lower than a height that does not obstruct an operator's view during the manned travel. The front plate 45 and the upper plate 46 are integrally formed.

As illustrated in FIG. 4, the right plate 47 is formed of a plate member located on the right side of the accommodation case 43. As illustrated in FIGS. 3 and 6, the left plate 48 is formed of a plate member located on the left side of the accommodation case 43. The rear plate 49 is formed of a plate member located at the rear of the accommodation case 43. The rear plate 49 has a surface that is curved in an arc shape so as to protrude rearward in a plan view, similarly to the rear surface 27 of the counterweight 16. In addition, the accommodation case 43 is disposed on the counterweight 16 so as to be located inside an outer edge of the counterweight 16 in a plan view. The rear plate 49, the right plate 47, and the left plate 48 are integrally formed, and are detachable from the bottom 44, the front plate 45, and the upper plate 46.

As illustrated in FIGS. 3 and 4, a base 50 that supports the accommodation case 43 is provided on the counterweight 16. As illustrated in FIG. 4, a rotary shaft 51 is provided in the base 50 near the right rear pillar 33. The axis of the rotary shaft 51 extends in the up-down direction, and a right end of the bottom 44 is attached to the rotary shaft 51. Therefore, the accommodation case 43 is rotatable generally horizontally about the rotary shaft 51 and is displaceable relative to the vehicle body 11. As illustrated in FIG. 6, when the accommodation case 43 is in a maximum displacement state, the accommodation case 43 is located behind the right rear pillar 33. The base 50 and the rotary shaft 51 correspond to a displacement mechanism that allows the accommodation case 43 to be displaced relative to the vehicle body 11. The base 50 has a stopper 52 that restricts rotary motion of the accommodation case 43 near the left rear pillar 33 (see FIGS. 3 and 6). The accommodation case 43 has a protrusion 53 at a left end of the bottom 44, and the protrusion 53 serves as an engaged portion to be engaged with the stopper 52. Disengaging the stopper 52 allows the accommodation case 43 to rotate.

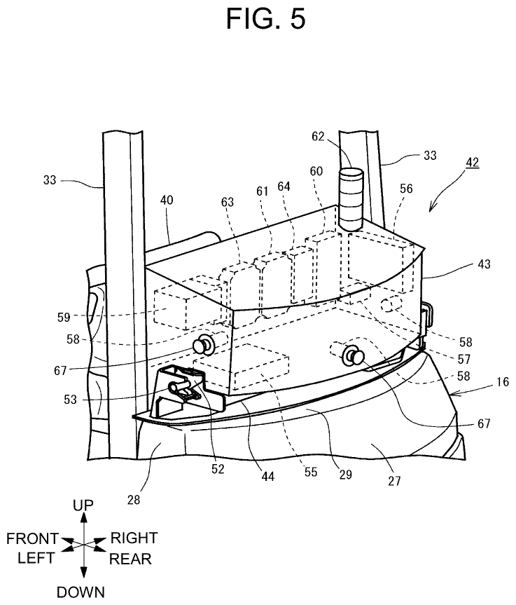

Next, the device group for the automated operation integrated in the accommodation case 43 will be described. As illustrated in FIG. 5, the device group for the automated operation includes an automated operation controller 55, a touch panel 56, a changeover switch device 57, an emergency stop device 58, a PLC unit 59, a DC-DC converter 60, a wireless communication device 61, a multilayer indication light 62, an emergency stop receiver 63, and a hub 64. The automated operation controller 55 is a device that controls devices related to the automated operation, and includes a CPU (not illustrated) executing various calculations and control programs, and a memory (not illustrated) storing various data and programs. Thus, the automated operation controller 55 controls the automated operation. The automated operation controller 55 is fixed to the bottom 44 of the accommodation case 43. The automated operation controller 55 is connected to the touch panel 56, the changeover switch device 57, the emergency stop device 58, the PLC unit 59, the DC-DC converter 60, the wireless communication device 61, the multilayer indication light 62, the emergency stop receiver 63, and the hub 64. In addition, the automated operation controller 55 is connected to an on-board controller (not illustrated) mounted on the main body 12. The on-board controller has a function of controlling the travel motor 18 and the cargo handling device 15 during both manned and unmanned travel.

The touch panel 56 has a panel screen 65 that is capable of displaying various types of information and on which information can be input with a touch (see FIGS. 4 and 5). Thus, the touch panel 56 corresponds to an input device on which data necessary for the automated operation can be input, and corresponds to a display device that displays information related to the automated operation. In the present embodiment, the touch panel 56 is attached to the accommodation case 43 so that the panel screen 65 is exposed at the right plate 47. By inputting information on the panel screen 65 of the touch panel 56 by the operator, for example, an emergency stop state may be released.

The changeover switch device 57 is a device equipped with a switch 66 for switching and selecting the automated operation or manual operation. In the present embodiment, the changeover switch device 57 is attached to the accommodation case 43 so that the switch 66 is exposed at the right plate 47. The emergency stop device 58 is a device for causing emergency stop of the unmanned travel of the forklift truck 10, and is provided with emergency stop buttons 67. In the present embodiment, the emergency stop buttons 67 are provided so as to protrude from the rear plate 49, the right plate 47, and the left plate 48, respectively, of the accommodation case 43. If any of the emergency stop buttons 67 is pressed during the unmanned travel by the automated operation, the forklift truck 10 immediately stops.

The PLC unit 59 is a device in which a plurality of PLCs (programmable logic controllers) are integrated to form a unit. The DC-DC converter 60 is a device for changing a DC voltage and performing voltage conversion. In the present embodiment, the DC-DC converter 60 is attached to the front plate 45 of the accommodation case 43. The wireless communication device 61 is provided for wireless communication with a host system (not illustrated) that manages the operation of the forklift truck 10 and the like.

The multilayer indication light 62 is a rod-shaped indicator light equipped with a plurality of lights arranged in the up-down direction, and has a red light 68, a yellow light 69, and a green light 70 arranged in this order from the top. The red light 68 is turned on when the forklift truck 10 is brought to an emergency stop. The yellow light 69 is turned on when an abnormality occurs in the forklift truck 10, and the green light 70 is turned on when the forklift truck 10 operates normally. In this embodiment, the multilayer indication light 62 is provided upright on the upper plate 46 of the accommodation case 43 near the right rear pillar 33.

The emergency stop receiver 63 is a receiver that receives a signal transmitted from the emergency stop device 58 when any of the emergency stop buttons 67 is pressed. The hub 64 is a device in which cables for communication between the automated operation controller 55 and devices are integrated. In the present embodiment, the PLC unit 59, the DC-DC converter 60, the wireless communication device 61, the emergency stop receiver 63, and the hub 64 are attached to the front plate 45 of the accommodation case 43. It is noted that power wiring and communication control wiring are pulled out together from near the right rear pillar 33 of the accommodation case 43.

The device group for the automatic operation includes a plurality of devices that are not integrated in the automated operation unit 42. Examples of the plurality of devices that are not integrated into the automated operation unit 42 include sensors provided in various parts of the vehicle body 11. In the present embodiment, such sensors include a plurality of obstacle detection sensors 71 protruding outward from the rear surface 27 of the counterweight 16, in addition to a front camera (not illustrated) and an obstacle detection sensor (not illustrated) provided in the cargo handling device 15 (see FIG. 2). Sensors of this type are connected to the automated operation controller 55. The obstacle detection sensors 71 are disposed so as to face rearward.

Next, the operation of the forklift truck 10 of the present embodiment will be described. When the forklift truck 10 is to perform unmanned travel by the automated operation, firstly, the operator sets the switch 66 of the changeover switch device 57 in the automated operation unit 42 to an automated operation position. Then, the operator performs necessary operations on the touch panel 56 to start the automated operation. Thus, the forklift truck 10 starts the automated operation and travels along a preset travel route. The forklift truck 10 travels while detecting an obstacle around the vehicle body 11.

During the unmanned travel, when the forklift truck 10 operates normally, only the green light 70 of the multilayer indication light 62 is kept turned on. When any abnormality occurs in the forklift truck 10, only yellow light 69 of the multilayer indication light 62 is turned on. When the forklift truck 10 is at the emergency stop, only red light 68 is turned on. It is noted that the forklift truck 10 is brought to the emergency stop if the any of the emergency stop buttons 67 is pressed during the unmanned travel.

When the forklift truck 10 is operated by an operator, the operator sets the switch 66 of the changeover switch device 57 in the automated operation unit 42 to a manual operation position. Then, the operator is seated on the driver's seat 40 and performs manned operation. When the forklift truck 10 moves backward during the manned operation, the operator checks the rear. The automated operation unit 42 is positioned at a height equal to or lower than the height of the driver's seat 40, and the automated operation unit 42 hardly obstructs the operator's rear view. In addition, since the automated operation unit 42 is mounted on the counterweight 16 so as to be positioned inside the outer edge of the counterweight 16 in a plan view, it is less likely to interfere with obstacles around the vehicle body 11 when the forklift truck 10 is travelling backward or turning.

Since the forklift truck 10 has the battery 19, when charging or replacing the battery, a space above the battery 19 has to be opened by removing the toe board 34 and rotating the seat stand 39 rearward to stand it up. In rotating the seat stand 39, the operator releases the stopper 52 so that the automated operation unit 42 mounted on the counterweight 16 does not obstruct rotating of the seat stand 39, and the automated operation unit 42 is rotated to be positioned behind the right rear pillar 33 (see FIG. 6). When charging or replacement of the battery 19 is completed, the operator folds down the seat stand 39. After the seat stand 39 is folded down, the automated operation unit 42 is rotated so as to be positioned on the counterweight 16, and the protrusion 53 is engaged with the stopper 52 to fix the automated operation unit 42.

Maintenance work will be performed on the various devices integrated in the automated operation unit 42. However, since the automated operation unit 42 is installed so as to be positioned at a height equal to or lower than the height of the driver's seat 40, a maintenance worker can easily perform maintenance without having to work at height using a stepladder or the like.

The forklift truck 10 of the present embodiment offers the following advantageous effects.
(1) The accommodation case 43 that accommodates the automated operation controller 55, the touch panel 56, and the emergency stop device 58 is mounted on the vehicle body 11 so as to be positioned at a height equal to or lower than the predetermined height. This configuration prevents the automated operation unit 42 from obstructing the operator's view, and secures the operator's view during the manned operation. In addition, positioning the automated operation unit 42 at the height equal to or lower than the predetermined height allows maintenance for the automated operation unit 42 to be performed easily, which increases the workability for the automated operation unit 42.
(2) The vehicle body 11 has the main body 12, the driver's seat 40 provided on the main body 12, and the counterweight 16 provided in the rear of the main body 12, and the accommodation case 43 is mounted on the counterweight 16 and behind the driver's seat 40. Therefore, when the forklift truck 10 moves forward during the manned operation, the automated operation unit 42 does not obstruct the operator's forward view. In addition, even when the forklift truck 10 moves backward during the manned operation, the automated operation unit 42 is prevented from obstructing the operator's rear view.
(3) The accommodation case 43 is positioned at a height equal to or lower than the height of the driver's seat 40, which prevents the automated operation unit 42 from obstructing the rear view of the operator even when the forklift truck moves backward during the manned operation.
(4) The accommodation case 43 is located inside the outer edge of the counterweight 16 in a plan view, which suppresses interference between the automated operation unit 42 and obstacles around the vehicle body 11 while the forklift truck 10 travels.
(5) The accommodation case 43 has the base 50 and the rotary shaft 51 functioning as the displacement mechanism that allows the accommodation case 43 to be displaced relative to the vehicle body 11. Thus, the accommodation case 43 can be displaced relative to the vehicle body 11 by the displacement mechanism. As a result, even when the driver's seat 40 is to be tilted backward, the automated operation unit 42 interfering with the backward tilting of the driver's seat 40 may be avoided.
(6) Since the emergency stop device 58 has the emergency stop buttons 67 protruding from the surface of the accommodation case 43, the emergency stop buttons 67 do not have to be provided in the vehicle body 11. As a result, there is no need to process the vehicle body 11 or run wiring to install the emergency stop buttons 67. In addition, since the emergency stop buttons 67 are provided on the accommodation case 43, there are almost no restrictions on the positions of the emergency stop buttons 67, and the positions of the emergency stop buttons 67 are intuitively easy to identify.
(7) Since the accommodation case 43 includes the multilayer indication light 62 that indicates the status of the forklift truck 10, the multilayer indication light 62 does not have to be provided in the vehicle body 11. As a result, there is no need to process the vehicle body 11 or run wiring to install the multilayer indication light 62.
(8) Since the automated operation unit 42 is integrated into the box-shaped accommodation case 43 that accommodates most of the device group for the automated operation, the automated operation unit 42 is not exclusively applicable to the forklift truck 10 of the present embodiment but is applicable to other models. In other words, application of the automated operation unit 42 is not dependent on the model of the forklift truck, and the automated operation unit 42 may be installed on various types of the forklift trucks. Furthermore, by using the automated operation unit 42, the manufacturing costs of the forklift truck 10 can be significantly reduced as compared to a case where a dedicated counterweight is provided to accommodate most of the device group for the automated operation.

### Second Embodiment

The following will describe a forklift truck according to a second embodiment. In this embodiment, the configuration and position of the automated operation unit are different from those of the first embodiment. In this embodiment, the same configurations as those in the first embodiment will be referred to the description of the first embodiment, and the same reference numerals will be used.

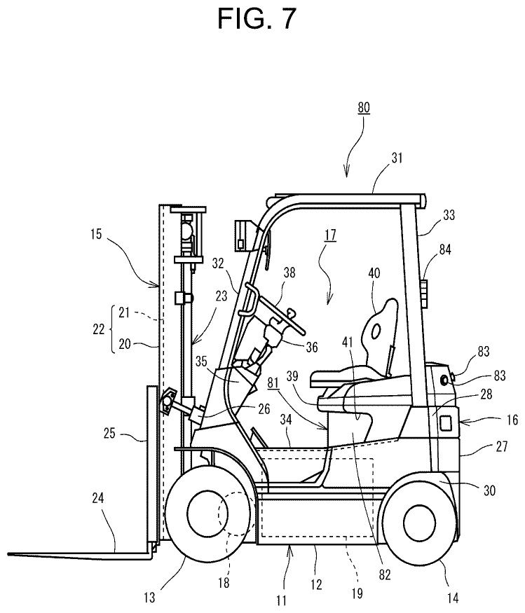

As illustrated in FIG. 7, a forklift truck 80 has an automated operation unit 81 disposed below the driver's seat 17 in the vehicle body 11. Specifically, the automated operation unit 81 is installed so as to fit into the recess 41 formed in the front part of the seat stand 39. The automated operation unit 81 has an accommodation case 82 and the device group for the automated operation that is integrated in the accommodation case 82.

The accommodation case 82 is formed by a plurality of plate members into a shape that fits the shape of the recess 41. The device group for the automated operation integrated into the accommodation case 82 includes the automated operation controller 55, the touch panel 56, the changeover switch device 57, the PLC unit 59, the DC-DC converter 60, the wireless communication device 61, the emergency stop receiver 63, and the hub 64. An emergency stop device 83 is provided in the counterweight 16. In addition, a multilayer indication light 84 is provided on the right rear pillar 33.

The forklift truck 80 of the second embodiment offers the same advantages as (1) and (3) of the first embodiment. Furthermore, according to the second embodiment, since the automated operation unit 81 is installed in the recess 41 formed in the front part of the seat stand 39, the automated operation unit 81 does not have to be displaced relative to the vehicle body 11. As a result, a displacement mechanism is not necessary, and the manufacturing cost may be reduced.

The present disclosure is not limited to the above-described embodiments, but may be modified in various manners within the scope of the disclosure, as exemplified below.

In the above first embodiment, the device group for the automated operation integrated into the accommodation case include the automated operation controller, the touch panel device, the changeover switch device, the emergency stop device, the PLC unit, the DC-DC converter, the wireless communication device, the multilayer indication light, the emergency stop receiver, and the hub, but the configuration is not limited to this. The device group for the automated operation integrated into the accommodation case only have to include at least an automated operation controller, a display device, an input device, and an emergency stop device.

In the above first embodiment, the automated operation unit is displaced relative to the vehicle body by rotating about the rotation axis as a fulcrum, but the configuration is not limited to this. The automated operation unit may be displaced relative to the vehicle body, for example, by sliding in the front-rear direction, the up-down direction, or the like, relative to the vehicle body. In this case, a guide rail for sliding the automated operation unit only has to be provided on the vehicle body.

In the above first embodiment, the automated operation unit is installed on the counterweight so as to be located inside the outer edge of the counterweight in a plan view, but the configuration is not limited to this. For example, the accommodation case may be located inside an obstacle detection sensor provided on the counterweight in a plan view. In this case, the automated operation unit may extend outside the counterweight. As a result, a space in the accommodation case can be increased, and interference between the automated operation unit and obstacles around the vehicle body while the forklift truck travels may be reduced.

In the above embodiments, the forklift truck is used as an example of the industrial vehicle, but the present disclosure is not limited to the forklift truck. The industrial vehicle only has to be any industrial vehicle capable of manned or unmanned travel other than a forklift truck, and may be, for example, a towing vehicle.

What is claimed is:

1. An industrial vehicle capable of manned travel and unmanned travel by automated operation, the industrial vehicle comprising:
a vehicle body; and
an automated operation unit that is mounted on the vehicle body and in which a plurality of devices for the automated operation is integrated, wherein
the plurality of devices includes:
an automated operation controller that controls the automated operation;
a display device on which information related to the automated operation is displayed;
an input device on which data related to the automated operation is input; and
an emergency stop device that causes an emergency stop of the automated operation,
the automated operation unit includes an accommodation case that accommodates the automated operation controller, the display device, the input device, and the emergency stop device, and
the accommodation case is positioned in the vehicle body at a height equal to or lower than a height that does not obstruct an operator's view during the manned travel.

2. The industrial vehicle according to claim 1, wherein
the vehicle body includes:
a main body;
a driver's seat mounted on the main body; and
a counterweight in a rear of the main body, and
the accommodation case is mounted on the counterweight and behind the driver's seat.

3. The industrial vehicle according to claim 2, wherein
the accommodation case is positioned at a height equal to or lower than the height of the driver's seat.

4. The industrial vehicle according to claim 2, wherein
the accommodation case is positioned inside an outer edge of the counterweight in a plan view.

5. The industrial vehicle according to claim 2, wherein
the counterweight has an obstacle detection sensor facing rearward, and
the accommodation case is disposed inside the obstacle detection sensor in a plan view.

6. The industrial vehicle according to claim 1, further comprising
a displacement mechanism that allows the accommodation case to be displaced relative to the vehicle body.

7. The industrial vehicle according to claim 1, wherein
the emergency stop device includes an emergency stop button protruding from a surface of the accommodation case.

8. The industrial vehicle according to claim 1, wherein
the accommodation case includes a multilayer indication light that indicates a state of the industrial vehicle.
